(19) United States
(12) Patent Application Publication
(10) Pub. No.: US 2020/0269968 A1
(43) Pub. Date: Aug. 27, 2020

(54) AIRFOIL AND MACHINE PROVIDED WITH SAME

(71) Applicant: MITSUBISHI HEAVY INDUSTRIES, LTD., Tokyo (JP)

(72) Inventor: Yasuro SAKAMOTO, Tokyo (JP)

(21) Appl. No.: 16/680,711

(22) Filed: Nov. 12, 2019

(30) Foreign Application Priority Data
Feb. 26, 2019 (JP) 2019-032583

(51) Int. Cl. B64C 5/06

(52) U.S. Cl. CPC B64C 5/06; F01D 5/141

(57) ABSTRACT

An airfoil includes an airfoil portion having a first airfoil surface and a second airfoil surface respectively extending along a spanwise direction between a leading edge and a trailing edge and having a symmetrical shape with respect to a chord, and at least one communication hole extending in the airfoil portion and having a first opening end opening to the first airfoil surface and a second opening end opening to the second airfoil surface. The first opening end is located on a first cross-section orthogonal to the spanwise direction. The second opening end is located on a second cross-section orthogonal to the spanwise direction. In the first cross-section or the second cross-section, an angle A1 exists within an angle range of −10 degrees or more and 10 degrees or less with reference to a straight line centered on the leading edge and parallel to an inflow direction of fluid.

### TECHNICAL FIELD

The present disclosure relates to an airfoil and a machine provided with the same.

### BACKGROUND

In an airfoil applied to a machine such as a fluid machine or an aircraft, loss due to the separation of a flow on an airfoil surface occurs, whereby the performance and operation efficiency of the machine may be reduced. Accordingly, an airfoil may be designed to reduce loss due to the separation of fluid or the like.

For example, Patent Document 1 discloses a turbine blade (airfoil) provided with a bypass flow passage penetrating from a belly side (pressure surface side) to a back side (suction surface side) in proximity to a supporting wall surface near a thickest part of an airfoil portion. In this turbine blade, a pressure difference between the belly side and the back side near the supporting wall surface is reduced by bypassing part of working fluid from the belly side to the back side via the above bypass flow passage at a position proximate to the supporting wall surface, whereby a secondary flow is reduced and flow loss is reduced.

### CITATION LIST

### Patent Literature

### Patent Document 1: JP2005-98203A

### SUMMARY

By the way, an operation may be performed under an operating condition deviated from a design point (e.g. partial load operation or the like) in a machine such as a fluid machine or an aircraft. Under the operating condition deviated from the design point, the separation of the flow may easily occur on a surface of the airfoil. Therefore, an airfoil is required on which the separation of fluid hardly occurs even if an operating condition of a machine deviates from a design point.

In view of the above situation, at least one embodiment of the present disclosure aims to provide an airfoil capable of suppressing separation, which possibly occurs on an airfoil surface, and a machine provided with the same.

(1) An airfoil according to at least one embodiment of the present disclosure is an airfoil with an airfoil portion having a first airfoil surface and a second airfoil surface respectively extending along a spanwise direction between a leading edge and a trailing edge and having a symmetrical shape with respect to a chord, and at least one communication hole extending in the airfoil portion and having a first opening end opening to the first airfoil surface and a second opening end opening to the second airfoil surface, wherein the first opening end is located on a first cross-section orthogonal to the spanwise direction at a first position in the spanwise direction, the second opening end is located on a second cross-section orthogonal to the spanwise direction at a second position in the spanwise direction, in the first cross-section or the second cross-section, an angle A1 satisfying a condition (a) exists within an angle range of −10 degrees or more and 10 degrees or less with reference to a straight line centered on the leading edge and parallel to an inflow direction of fluid into the airfoil portion in an operating condition at a design point of a device to which the airfoil is mounted, and the condition (a) is such that a static pressure at a position of the first opening end on the first airfoil surface and a static pressure at a position of the second opening end on the second airfoil surface are equal when the airfoil portion receives a flow of the fluid in a direction toward the leading edge from a direction of the angle A1.

In the above configuration (1), the static pressure is equal at the position of the first opening end on the first airfoil surface and at the position of the second opening end on the second airfoil surface when the airfoil portion receives the flow of the fluid from the above direction of the angle A1. Thus, since a direction of the flow of the fluid toward the airfoil portion is close to the direction of the angle A1 during an operation near the design point of the device to which the airfoil is applied, there is almost no pressure difference between the position of the first opening end and the position of the second opening end and a flow passing through the communication hole provided in the airfoil portion is hardly generated. On the other hand, if the operating condition deviates from the design point, a pressure difference is created between the position of the first opening end on the first airfoil surface and the position of the second opening end on the second airfoil surface and a flow passing through the communication hole is generated from the opening end on a high pressure side to the opening end on a low pressure side. By the exit of this flow from the opening end on the low pressure side, momentum is supplied to a flow (main flow) near the airfoil surface (first airfoil surface or second airfoil surface) provided with the opening end on the low pressure side. Thus, the separation of the flow, which possibly occurs on the airfoil surface, can be suppressed.

Therefore, according to the above configuration (1), the separation of the flow on the airfoil surface, which possibly occurs when the operating condition deviates from the design point, can be suppressed and an operation range (e.g. elevation angle range or the like) in which loss can be reduced can be expanded while a performance reduction during the operation near the design point is suppressed.

(2) An airfoil according to at least one embodiment of the present disclosure is an airfoil with an airfoil portion having a first airfoil surface and a second airfoil surface respectively extending along a spanwise direction between a leading edge and a trailing edge and having a symmetrical shape with respect to a chord, and at least one communication hole extending in the airfoil portion and having a first opening end opening to the first airfoil surface and a second opening end opening to the second airfoil surface, wherein the first opening end is located on a first cross-section orthogonal to the spanwise direction at a first position in the spanwise direction, the second opening end is located on a second cross-section orthogonal to the spanwise direction at a second position in the spanwise direction, and when X1 represents a dimensionless chord length position (%) of the first opening end with reference to the leading edge on the first cross-section and X2 represents a dimensionless chord length position (%) of the second opening end with reference to the leading edge on the second cross-section, an angle of an inflow direction of fluid into the airfoil portion with reference to a chord direction in an operating condition at a design point of a device to which the airfoil is mounted is 0 degrees, and an absolute value |X1-X2| of a difference between the dimensionless chord length position X1 of the first opening end and the dimensionless chord length position X2 of the second opening end is not greater than 5%, or the angle of the inflow direction of the fluid into the airfoil portion with reference to the chord direction in the operating condition at the design point of the device to which the airfoil is mounted is greater than 0 degrees, the inflow direction is a direction facing the first airfoil surface, and the dimensionless chord length position X1 of the first opening end opening to the first airfoil surface is larger than the dimensionless chord length position X2 of the second opening end opening to the second airfoil surface.

In a case of a symmetrical airfoil in which a pair of airfoil surfaces have a symmetrical shape with respect to a chord, static pressures on the both airfoil surfaces are basically equal at the same position (or at the same dimensionless chord length position) in a chord direction when a flow of fluid in a direction parallel to the chord direction is received.

In this respect, in the above configuration (2), the first and second opening ends are respectively provided at positions where the dimensionless chord length positions are close to each other (i.e. to reduce the above difference between X1 and X2) in a symmetrical airfoil in which the angle of the inflow direction of the fluid with respect to the chord direction in the operating condition at the design point is set to 0 degrees. Thus, during the operation near the design point, a pressure difference can be almost eliminated between the position of the first opening end and the position of the second opening end. Therefore, a flow passing through the communication hole provided in the airfoil portion is hardly generated. On the other hand, if the operating condition deviates from the design point, a pressure difference is created between the position of the first opening end on the first airfoil surface and the position of the second opening end on the second airfoil surface and a flow passing through the communication hole is generated from the opening end on the high pressure side to the opening end on the low pressure side. By the exit of this flow from the opening end on the low pressure side, momentum is supplied to a flow (main flow) near the airfoil surface (first airfoil surface or second airfoil surface) provided with the opening end on the lower pressure side. Thus, the separation of the flow, which possibly occurs on this airfoil surface, can be suppressed.

Further, in a case of a symmetrical airfoil, the static pressure on one airfoil surface facing a flow is higher than the static pressure on the other airfoil surface at the same position in the chord direction on the both airfoil surfaces when the airfoil receives the flow from a direction of an angle inclined with respect to the chord direction. Thus, at this time, out of the positions where the static pressures are equal on the both airfoil surfaces, the position on the one airfoil surface facing the flow is closer to the trailing edge than the position on the other airfoil surface.

In this respect, in the above configuration (2), the first opening end on the first airfoil surface is provided closer to the trailing edge side than the second opening end on the second airfoil surface (i.e. X1 is greater than X2) in the symmetrical airfoil in which the angle of the inflow direction of the fluid with respect to the chord direction in the operating condition at the design point is greater than 0 degrees and the inflow direction is set to face the first airfoil surface. Thus, a pressure difference can be almost eliminated between the position of the first opening end and the position of the second opening end during an operation near the design point. Therefore, a flow passing through the communication hole provided in the airfoil portion is hardly generated. On the other hand, if the operating condition deviates from the design point, a pressure difference is created between the position of the first opening end on the first airfoil surface and the position of the second opening end on the second airfoil surface and a flow passing through the communication hole is generated from the opening end on the high pressure side to the opening end on the low pressure side. By the exit of this flow from the second opening end on the low pressure side, momentum is supplied to a flow (main flow) near the airfoil surface (first airfoil surface or second airfoil surface) provided with the opening end on the low pressure side. Thus, the separation of the flow, which possibly occurs on this airfoil surface, can be suppressed.

Therefore, according to the above configuration (2), the separation of the flow on the airfoil surface, which possibly occurs when the operating condition deviates from the design point, can be suppressed and the operation range (e.g. elevation angle range or the like) in which loss can be reduced can be expanded while a performance reduction during the operation near the design point is suppressed.

(3) In several embodiments, in the above configuration (1) or (2), at least one of the first opening end or the second opening end is located closer to the leading edge than a point on the first airfoil surface or the second airfoil surface having a tangent parallel to a chord direction of the airfoil portion.

When the operating condition of the device to which the airfoil is applied deviates from the design point, separation may easily occur at a position closer to the trailing edge than the above point (tangent point to the tangent parallel to the chord direction) on the first airfoil surface or the second airfoil surface. In this respect, according to the above configuration (3), since the first opening end or the second opening end is provided closer to the leading edge than the position where separation easily occurs on the first airfoil surface or the second airfoil surface, the separation of the fluid, which easily occurs on the first airfoil surface or the second airfoil surface, can be effectively suppressed under the operating condition deviated from the design point.

(4) In several embodiments, in any one of the above configurations (1) to (3), the communication hole extends linearly between the first opening end and the second opening end.

According to the above configuration (4), since the communication hole has a linear shape, the communication hole can be easily formed by machining.

(5) In several embodiments, in any one of the above configurations (1) to (4), an angle formed by a part closer to the leading edge than the first opening end, out of a tangent to the first airfoil surface at the first opening end, and the communication hole at the first opening end is not greater than 45 degrees when viewed from the spanwise direction.

According to the above configuration (5), since the communication hole has a shape along the first airfoil surface at the position of the first opening end, mixing loss with the fluid flowing near the first airfoil surface can be reduced when the flow from the communication hole exits from the first opening end.

(6) In several embodiments, in any one of the above configurations (1) to (5), an angle formed by a part closer to the leading edge than the second opening end, out of a tangent to the second airfoil surface at the second opening end, and the communication hole at the second opening end is not greater than 45 degrees.

According to the above configuration (6), since the communication hole has a shape along the second airfoil surface at the position of the second opening end when viewed from the spanwise direction, mixing loss with the fluid flowing near the second airfoil surface can be reduced when the flow from the communication hole exits from the second opening end.

(7) In several embodiments, in any one of the above configurations (1) to (6), the first opening end and the second opening end are located at the same position in the spanwise direction.

According to the above configuration (7), since the first opening end and the second opening end are located at the same position in the spanwise direction, the communication hole can be relatively easily formed in the airfoil portion.

(8) In several embodiments, in any one of the above configurations (1) to (6), the first opening end and the second opening end are located at different positions in the spanwise direction.

According to the above configuration (8), since the first opening end and the second opening end are located at different positions in the spanwise direction, the separation of the fluid flowing along a surface of the airfoil portion, which possibly occurs on the airfoil surface, can be effectively suppressed by the flow exiting from the communication hole when the static pressures on the airfoil surfaces are equal at these positions.

(9) A machine according to at least one embodiment of the present disclosure includes the airfoil according to any one of the above (1) to (8).

The airfoil provided in the above machine (9) has the above configuration (1) or (2). That is, in the above configuration (9), as described the above (1) or (2), there is almost no pressure difference between the position of the first opening end and the position of the second opening end and a flow passing through the communication hole provided in the airfoil portion is hardly generated during an operation near the design point of the machine. On the other hand, if the operating condition deviates from the design point, a pressure difference is created between the position of the first opening end on the first airfoil surface and the position of the second opening end on the second airfoil surface and a flow passing through the communication hole is generated from the opening end on the high pressure side to the opening end on the low pressure side. By the exit of this flow from the opening end on the low pressure side, momentum is supplied to a flow (main flow) near the airfoil surface (first airfoil surface or second airfoil surface) provided with the opening end on the low pressure side. Thus, the separation of the flow, which possibly occurs on this airfoil surface, can be suppressed.

Thereafter, according to the above configuration (9), the separation of the flow on the airfoil surface, which possibly occurs when the operating condition deviates from the design point, can be suppressed and the operation range (e.g. elevation angle range or the like) in which loss can be reduced can be expanded while a performance reduction during the operation near the design point is suppressed.

According to at least one embodiment of the present disclosure, an airfoil capable of suppressing separation, which possibly occurs on an airfoil surface, and a machine provided with the same are provided.

### BRIEF DESCRIPTION OF DRAWINGS

FIG. 1 is a schematic configuration diagram of an aircraft according to one embodiment,

FIG. 2 is a perspective view of an airfoil (vertical tail) according to one embodiment,

FIG. 3 is a perspective view of an airfoil (vertical tail) according to one embodiment,

FIG. 4A is a diagram schematically showing a cross-sectional shape on a first cross-section of an airfoil according to one embodiment,

FIG. 4B is a diagram schematically showing a cross-sectional shape on a second cross-section of the airfoil according to the one embodiment,

FIG. 5A is a diagram schematically showing a cross-sectional shape on a first cross-section of an airfoil according to one embodiment,

FIG. 5B is a diagram schematically showing a cross-sectional shape on a second cross-section of the airfoil according to the one embodiment,

FIG. 6 is a graph showing an example of a relationship of an elevation angle and a lift coefficient in the airfoil,

FIG. 7 is a graph showing an example of a relationship of the elevation angle and a drag coefficient in the airfoil,

FIG. 8 is a diagram schematically showing a partial cross-section of an airfoil portion according to one embodiment,

FIG. 9 is a diagram schematically showing a partial cross-section of an airfoil portion according to one embodiment,

FIG. 10A is a diagram showing the symmetry of the airfoil portion,

FIG. 10B is a diagram showing the symmetry of the airfoil portion, and

FIG. 11 is a diagram schematically showing a partial cross-section of an airfoil portion according to one embodiment.

### DETAILED DESCRIPTION

Several embodiments of the present disclosure will be described below with reference to the accompanying drawings. It is intended, however, that dimensions, materials, shapes, relative positions and the like of components described in the embodiments or shown in the drawings shall be interpreted as illustrative only and not limitative of the scope of the present disclosure.

First, an aircraft, which is an example of a machine to which an airfoil according to several embodiments is applied, is described. It should be noted that the machine according to the present disclosure is not limited to aircrafts and may be, for example, a fluid machine such as a gas turbine.

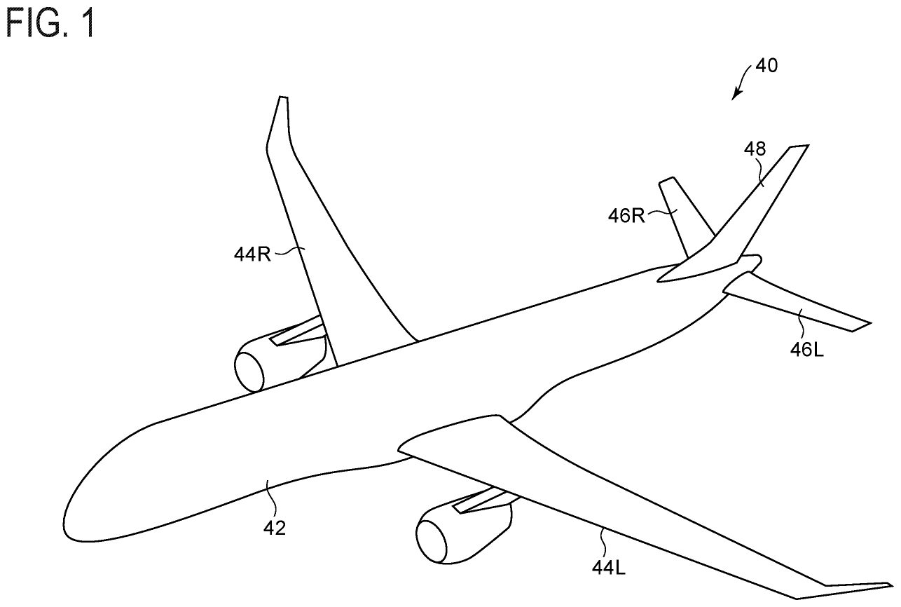

FIG. 1 is a schematic configuration diagram of an aircraft according to one embodiment. As shown in FIG. 1, the aircraft 40 includes a fuselage 42, a pair of main wings 44 (left main wing 44L and right main wing 44R), a pair of horizontal tails 46 (left horizontal tail 46L and right horizontal tail 46R) and a vertical tail 48. In the aircraft 40 shown in FIG. 1, each of the main wings 44, the horizontal tails 46 and the vertical tail 48 is mounted to the fuselage 42.

The airfoil according to several embodiments may be the horizontal tail 46 or the vertical tail 48 of the aforementioned aircraft 40. The above vertical tail 48 is described as an example of the airfoil according to the several embodiments below.

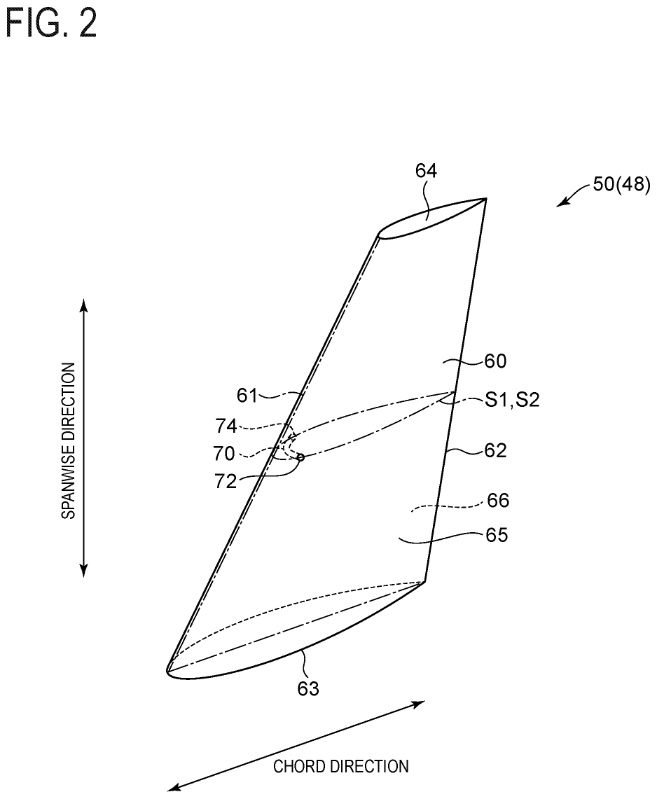

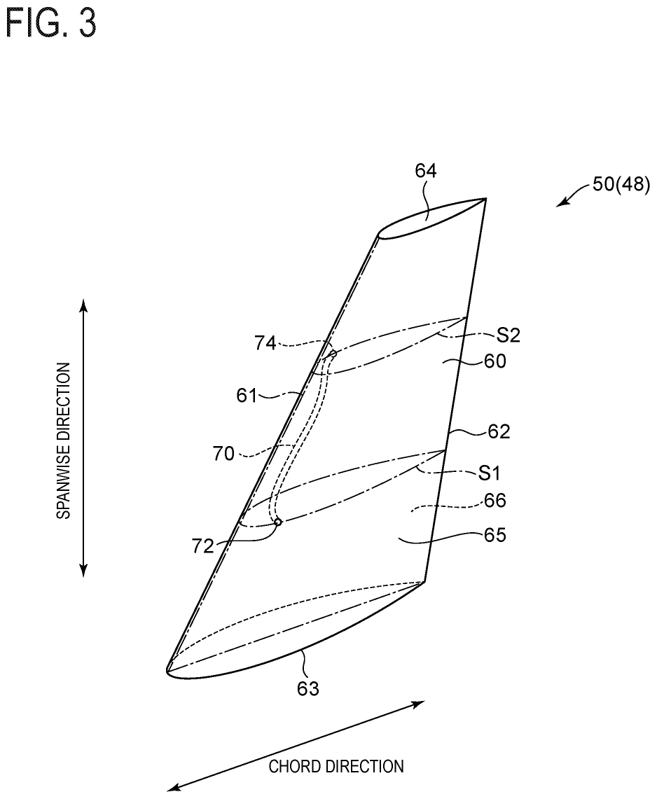

Each of FIGS. 2 and 3 is a perspective view of an airfoil 50 (vertical tail 48) according to one embodiment. As shown in FIGS. 2 and 3, the airfoil 50 includes an airfoil portion 60 extending along a spanwise direction between a base end 63 and a tip 64. It should be noted that the base end 63 of the airfoil portion 60 is connected to the fuselage 42 of the aircraft 40 (see FIG. 1). The airfoil portion 60 has a first airfoil surface 65 and a second airfoil surface 66 extending between a leading edge 61 and a trailing edge 62 along the spanwise direction. The first and second airfoil surfaces 65, 66 typically have a convex shape projecting from the inside toward the outside of the airfoil portion 60 when viewed in the spanwise direction. The first and second airfoil surfaces 65, 66 have a symmetrical shape with respect to a chord of the airfoil portion 60.

Here, that “the first and second airfoil surfaces 65, 66 have a symmetrical shape with respect to the chord of the airfoil portion 60” includes a case where the first and second airfoil surfaces 65, 66 are perfectly symmetrical with respect to the chord, but is not limited to this. In this specification, “the first and second airfoil surfaces 65, 66 have a symmetrical shape with respect to the chord of the airfoil portion 60” shall also include a case where the following condition is satisfied.

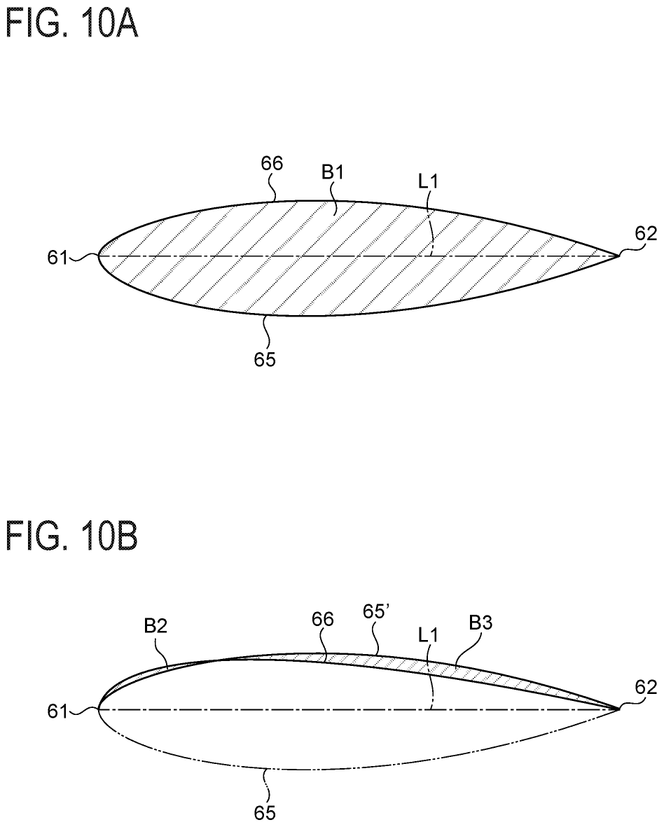

Condition: When B1 (see FIG. 10A) represents an entire cross-sectional area of the airfoil portion 60 orthogonal to the spanwise direction and (B2+B3) (see FIG. 10B) represents an area of parts where a cross-sectional part on the side of the first airfoil surface 65 and a cross-sectional part on the side of the second airfoil surface 66 do not overlap when the cross-sectional shape of the airfoil portion 60 is folded along a chord line L1 of the airfoil portion 60, a ratio {(B2+B3)/B1} of the area (B2+B3) to the area B1 is not more than 10%.

It should be noted that FIGS. 10A and 10B are diagrams showing the symmetry of the airfoil portion 60, wherein FIG. 10A is a diagram showing a cross-section orthogonal to the spanwise direction of the airfoil portion 60 and FIG. 10B is a diagram when the cross-section of the airfoil portion 60 shown in FIG. 10A is folded along the chord line L1.

As shown in FIGS. 2 and 3, the airfoil portion 60 is provided with a communication hole 70 extending in the airfoil portion 60. The communication hole 70 has a first opening end 72 opening to the first airfoil surface 65 and a second opening end 74 opening to the second airfoil surface 66. The first opening end 72 opening to the first airfoil surface 65 is located on a first cross-section S1 orthogonal to the spanwise direction at a first position in the spanwise direction. Further, the second opening end 74 opening to the second airfoil surface 66 is located on a second cross-section S2 orthogonal to the spanwise direction at a second position in the spanwise direction.

In an illustrative embodiment shown in FIG. 2, the first position where the first cross-section S1 is located and the second position where the second cross-section S2 is located are the same position in the spanwise direction, i.e. the first and second opening ends 72, 74 are located on the same cross-section (first cross-section S1 and second cross-section S2). In an illustrated embodiment shown in FIG. 3, the first position where the first cross-section S1 is located and the second position where the second cross-section S2 is located are different in the spanwise direction. More specifically, in the illustrative embodiment shown in FIG. 3, the first position where the first cross-section S1 is located is located closer to the base end 63 in the spanwise direction than the second position where the second cross-section S2 is located, i.e. the first opening end 72 is open to the first airfoil surface 65 at a position closer to the base end 63 than the second opening end 74 opening to the second airfoil surface 66 in the spanwise direction.

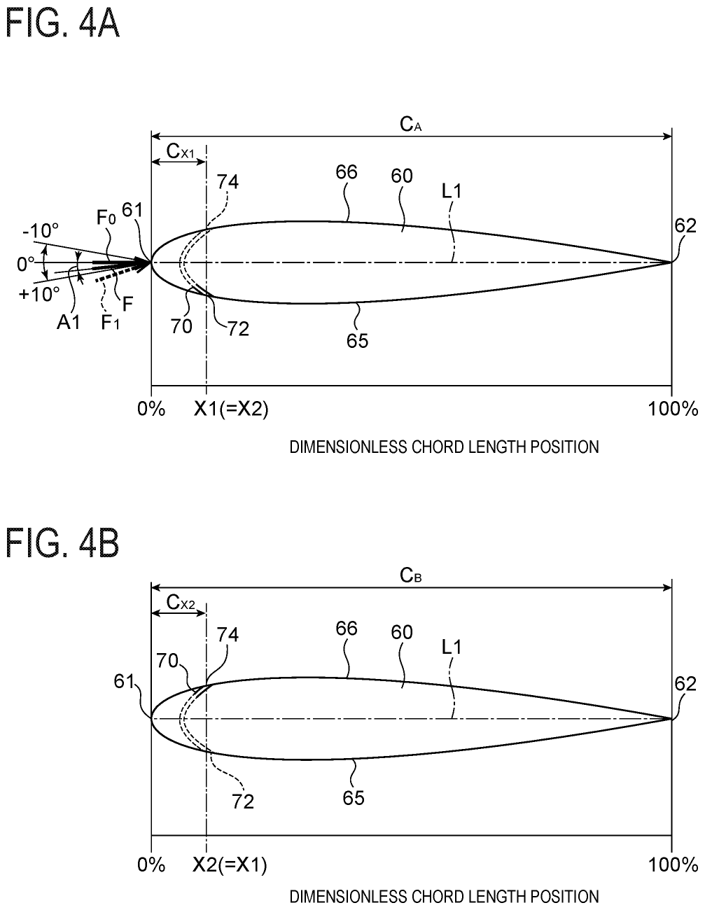

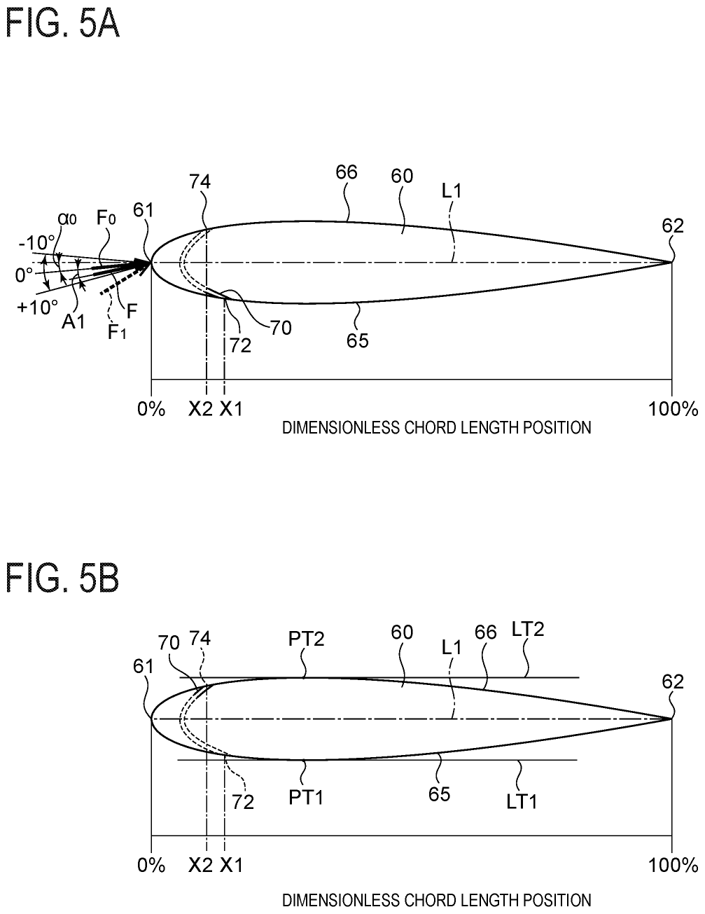

FIGS. 4A and 4B are diagrams respectively schematically showing cross-sectional shapes of an airfoil 50 according to one embodiment on the first cross-section S1 and the second cross-section S2. Further, FIGS. 5A to 5B are diagrams respectively schematically showing cross-sectional shapes of an airfoil 50 according to another embodiment on the first cross-section S1 and the second cross-section S2.

Here, X1 is defined as a dimensionless chord length position (%) of the first opening end 72 with reference to the leading edge 61 on the first cross-section S1 and X2 is defined as a dimensionless chord length position (%) of the second opening end 74 with reference to the leading edge 61 on the second cross-section S2.

In this specification, a dimensionless chord length position (%) with reference to the leading edge 61 on a cross-section orthogonal to the spanwise direction means a position (%) when the position of the leading edge 61 in a chord direction (direction connecting the leading edge 61 and the trailing edge 62) on this cross-section is 0% and the position of the trailing edge 62 is 100%.

For example, if C_{A} represents a chord direction length of the airfoil portion 60 and C_{X1} represents a chord direction length from the leading edge 61 to the first opening end 72 on the first cross-section S1 as shown in FIG. 4A, the dimensionless chord length position X1 (%) of the first opening end 72 with reference to the leading edge 61 on the first cross-section S1 is (C_{X1}/C_{A}). Further, if C_{B} represents a chord direction length of the airfoil portion 60 and C_{X2} represents a chord direction length from the leading edge 61 to the second opening end 74 on the second cross-section S2 as shown in FIG. 4B, the dimensionless chord length position X2 (%) of the second opening end 74 with reference to the leading edge 61 on the second cross-section S2 is (C_{X2}/C_{B}).

It should be noted that, by using the aforementioned dimensionless chord length positions, the chord direction position of the first opening end 72 on the first cross-section S1 and that of the second opening end 74 on the second cross-section S2 can be properly compared even if the cross-section of the airfoil portion 60 differs in the spanwise direction, if the airfoil portion 60 has a twisted shape or the like.

The airfoil 50 according to the one embodiment is designed such that an angle of an inflow direction of fluid into the airfoil portion 60 with respect to the chord direction in an operating condition at a design point of a device to which the airfoil 50 is mounted is 0 degrees. An absolute value |X1-X2| of a difference between the dimensionless chord length position X1 of the first opening end 72 opening to the first airfoil surface 65 and the dimensionless chord length position X2 of the second opening end 74 opening to the second airfoil surface 66 is not greater than 5%.

For example, the airfoil (vertical tail 48) shown in FIGS. 4A and 4B is designed such that an angle of an inflow direction (direction of an arrow F0 in FIG. 4) of air (fluid) into the airfoil portion 60 with respect to the chord direction (direction of the chord line L1) in a cruise operating condition (operating condition at a design point) of the aircraft 40 (device) to which the airfoil 50 is mounted is 0 degrees. The dimensionless chord length position X1 of the first opening end 72 opening to the first airfoil surface 65 and the dimensionless chord length position X2 of the second opening end 74 opening to the second airfoil surface 66 are equal. In other words, the absolute value |X1-X2| of the difference between X1 and X2 is zero.

In the case of a symmetrical airfoil in which a pair of airfoil surfaces (first airfoil surface 65 and second airfoil surface 66) have a symmetrical shape with respect to the chord as in the above embodiment, static pressures on the both airfoil surfaces are basically equal at the same position (or at the same dimensionless chord length position) in the chord direction when a flow of fluid in a direction (direction of the arrow F0 in FIG. 4A) parallel to the chord direction is received.

In this respect, in the above embodiment, the first and second opening ends 72, 74 are respectively provided at positions where the dimensionless chord length positions are close to each other (i.e. to reduce the above difference between X1 and X2) in the symmetrical airfoil (airfoil 50) in which the angle of the inflow direction of the fluid with respect to the chord direction in the operating condition at the design point is set to 0 degrees. Thus, during the operation near the design point, a pressure difference can be almost eliminated between the position of the first opening end 72 on the first airfoil surface 65 and the position of the second opening end 74 on the second airfoil surface 66. Therefore, a flow passing through the communication hole 70 provided in the airfoil portion 60 is hardly generated.

On the other hand, if the operating condition deviates from the design point, a pressure difference is created between the position of the first opening end 72 on the first airfoil surface 65 and the position of the second opening end 74 on the second airfoil surface 66 and a flow passing through the communication hole 70 is generated from the opening end on a high pressure side to the opening end on a low pressure side. For example, if the operating condition deviates from the design point and the inflow direction of the fluid into the airfoil portion 60 is inclined with respect to the chord direction and becomes a direction facing the first airfoil surface 65 (direction of an arrow F1 in FIG. 4A), the static pressure at the position of the first opening end 72 becomes greater than the static pressure at the position of the second opening end 74. Then, a flow passing through the communication hole 70 is generated from the first opening end 72 on the high pressure side to the second opening end 74 on the low pressure side. By the exit of this flow from the second opening end 74 on the low pressure side, momentum is supplied to a flow (main flow) near the second airfoil surface 66 provided with the second opening end 74. Thus, the separation of the flow, which possibly occurs on the second airfoil surface 66, can be suppressed.

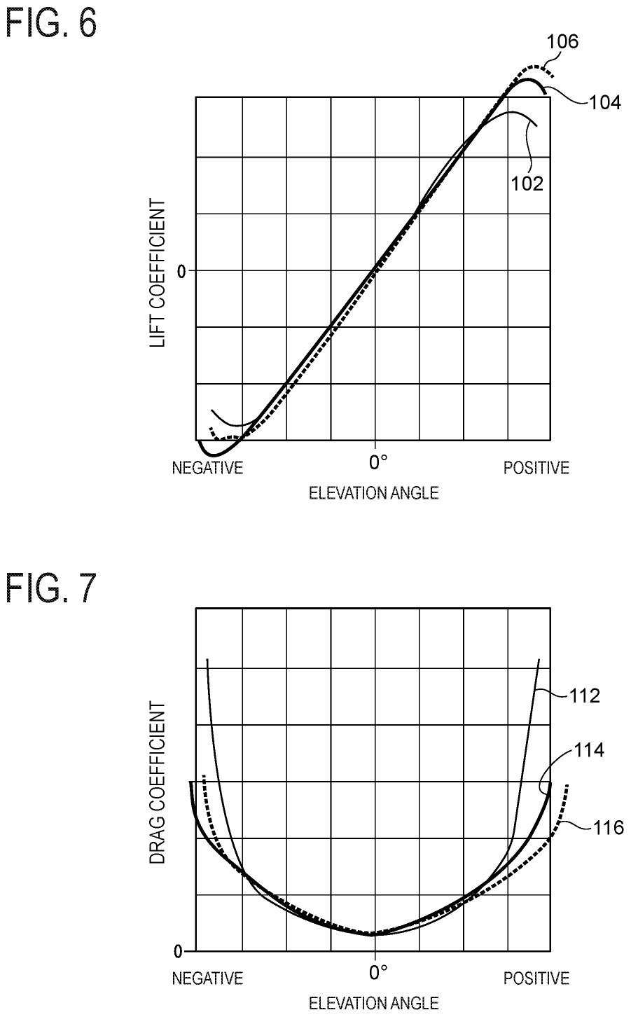

Here, FIG. 6 is a graph showing several examples of a relationship of an elevation angle and a lift coefficient in the airfoil, and FIG. 7 is a graph showing several examples of a relationship of the elevation angle and a drag coefficient in the airfoil.

FIG. 6 shows a curve 102 representing the relationship of the elevation angle and the lift coefficient according to a conventional symmetrical airfoil not provided with the above communication hole and a curve 104 representing the relationship of the elevation angle and the lift coefficient according to the embodiment shown in FIGS. 4A and 4B. A curve 106 in FIG. 6 will be described later.

FIG. 7 shows a curve 112 representing the relationship of the elevation angle and the drag coefficient according to the conventional symmetrical airfoil not provided with the above communication hole and a curve 114 representing the relationship of the elevation angle and the drag coefficient according to the embodiment shown in FIGS. 4A and 4B. A curve 116 in FIG. 7 will be described later.

It should be noted that the elevation angle is an angle indicating the inflow direction of the fluid with respect to the chord direction. The elevation angle is 0 degrees when the inflow direction is parallel to the chord direction. Further, the elevation angle is defined to be positive when the inflow direction is inclined with respect to the chord direction to face the first airfoil surface 65, and the elevation angle is defined to be negative when the inflow direction is inclined with respect to the chord direction to face the second airfoil surface 66.

In the case of the conventional symmetrical airfoil not provided with the above communication hole, the lift coefficient changes in proportion to the elevation angle in an elevation angle range including 0 degrees, but the lift coefficient increases at a lower rate as the elevation angle increases when the elevation angle increases to a certain extent, and the lift coefficient decreases when the elevation angle further increases as shown in FIG. 6 (see the curve 102). Further, as shown in FIG. 7 (see the curve 112), the drag coefficient increases as the elevation angle increases, but the drag coefficient drastically increases in an elevation angle range where the lift coefficient decreases.

On the other hand, in the case of the airfoil 50 according to the embodiment provided with the communication hole 70, an elevation angle range in which the lift coefficient increases in proportion to the elevation angle is expanded and the lift coefficient increases up to a greater elevation angle as compared to the conventional example as shown in FIG. 6 (see a curve 104). Further, as shown in FIG. 7 (see a curve 114), the drag coefficient is reduced as compared to the conventional example in a high elevation angle region. This is thought to be because the separation of a flow, which possibly occurs on the airfoil surface, can be suppressed since a flow via the communication hole 70 can be generated as described above even under such an operating condition that separation possibly occurs in the airfoil 50 according to the embodiment shown in FIGS. 4A and 4B.

Therefore, an operation range (e.g. elevation angle range or the like) in which loss can be reduced can be expanded by employing the airfoil 50 according to the above embodiment.

Further, an airfoil 50 according to another embodiment is designed such that an angle of an inflow direction into an airfoil portion 60 with respect to a chord direction in an operating condition at a design point of a device to which the airfoil 50 is mounted is greater than 0 degrees. On a side closer to the leading edge than a position where the static pressure is minimum on the airfoil surface, a dimensionless chord length position X1 of a first opening end 72 opening to a first airfoil surface 65 is larger than a dimensionless chord length position X2 of a second opening end 74 opening to a second airfoil surface 66 (i.e. X2<X1 is satisfied).

For example, the airfoil 50 (vertical tail 48) shown in FIGS. 5A and 5B is designed such that an angle α0 of an inflow direction (direction of an arrow F0 in FIG. 5A) of air (fluid) into the airfoil portion 60 in a cruise operating condition (operating condition at a design point) of the aircraft 40 (device) to which the airfoil 50 is mounted is greater than 0 degrees, i.e. the above inflow direction is inclined with respect to the chord direction (direction of the chord line L1). In the case of installation on a side closer to the leading edge than a position where the static pressure is minimum on the airfoil surface, a dimensionless chord length position X1 of a first opening end 72 opening to a first airfoil surface 65 is larger than a dimensionless chord length position X2 of a second opening end 74 opening to a second airfoil surface 66.

In the case of a symmetrical airfoil in which a pair of airfoil surfaces (first airfoil surface 65 and second airfoil surface 66) have a symmetrical shape with respect to a chord as in the above embodiment, a static pressure on one airfoil surface facing a flow is higher than a static pressure on the other airfoil surface at the same position in the chord direction on the both airfoil surfaces when the flow from a direction of an angle inclined with respect to the chord direction is received. Thus, at this time, out of the positions where the static pressures are equal on the both airfoil surfaces, the position on the one airfoil surface facing the flow is closer to the trailing edge side or the leading edge side than the position on the other airfoil surface.

For example, when a flow is received from a direction (arrow F0 in FIG. 5A) inclined with respect to the chord direction and facing the first airfoil surface 65 as shown in FIG. 5A, the static pressure on the first airfoil surface 65 facing the flow is higher than the static pressure on the second airfoil surface 66 at the same position in the chord direction on the both airfoil surfaces. Thus, at this time, out of the positions where the static pressures are equal on the both airfoil surfaces, the position on the first airfoil surface 65 facing the flow is closer to the trailing edge side than the position on the second airfoil surface 66 when the communication hole is arranged as in FIG. 5A.

In this respect, in the above embodiment, the first opening end 72 on the first airfoil surface 65 is provided closer to the trailing edge 62 than the second opening end 74 on the second airfoil surface 66 (i.e. X1 is greater than X2) in the symmetrical airfoil (airfoil 50) in which the angle of the inflow direction of the fluid with respect to the chord direction in the operating condition at the design point is greater than 0 degrees and the inflow direction is set to face the first airfoil surface 65. Thus, a pressure difference can be almost eliminated between the position of the first opening end 72 on the first airfoil surface 65 and the position of the second opening end 74 on the second airfoil surface 66 during an operation near the design point. Therefore, a flow passing through the communication hole 70 provided in the airfoil portion 60 is hardly generated.

On the other hand, if the operating condition deviates from the design point, a pressure difference is created between the position of the first opening end 72 on the first airfoil surface 65 and the position of the second opening end 74 on the second airfoil surface 66 and a flow passing through the communication hole 70 is generated from the opening end on the high pressure side to the opening end at the low pressure side. For example, if the operating condition deviates from the design point and the inflow direction of the fluid into the airfoil portion 60 is further inclined with respect to the chord direction and becomes a direction facing the first airfoil surface 65 (direction of an arrow F1 in FIG. 5A) (at this time, an angle of inclination of the inflow direction of the fluid with respect to the chord direction is greater than the above angle α0), the static pressure at the position of the first opening end 72 becomes greater than the static pressure at the position of the second opening end 74. Then, a flow passing through the communication hole 70 is generated from the first opening end 72 on the high pressure side to the second opening end 74 on the low pressure side. By the exit of this flow from the second opening end 74 on the low pressure side, momentum is supplied to a flow (main flow) near the second airfoil surface 66 provided with the second opening end 74. Thus, the separation of the flow, which possibly occurs on the second airfoil surface 66, can be suppressed.

Here, the curve 106 in FIG. 6 represents the relationship of the elevation angle and the lift coefficient according to the embodiment shown in FIGS. 5A and 5B, and the curve 116 in FIG. 7 represents the relationship of the elevation angle and the drag coefficient according to the embodiment shown in FIGS. 5A and 5B.

In the case of the airfoil 50 according to the embodiment shown in FIGS. 5A and 5B, the elevation angle range in which the lift coefficient increases in proportion to the elevation angle is further expanded and the lift coefficient increases up to a further greater elevation angle as shown in FIG. 6 (see the curve 106) as compared to the case of the airfoil 50 shown in FIGS. 4A and 4B (see the curve 104). Further, as shown in FIG. 7 (see the curve 116), the drag coefficient is further reduced in the high elevation angle region as compared to the case of the airfoil 50 (see the curve 114) shown in FIGS. 4A and 4B.

This is because the separation of the flow, which possibly occurs on the airfoil surface, can be more effectively suppressed since the opening end (second opening end 74) on the low pressure side where the flow passing through the communication hole 70 exits when the operating condition deviates from the design point is provided closer to the leading edge than in the case shown in FIGS. 4A and 4B in the airfoil 50 according to the embodiment shown in FIGS. 5A and 5B and, hence, a flow via the communication hole 70 can be generated even in a larger elevation angle region.

Accordingly, the operation range (e.g. elevation angle range or the like) in which loss can be reduced can be expanded by employing the airfoil 50 according to the above embodiment.

As described above, according to the above embodiment, the separation of the flow on the airfoil surface, which possibly occurs when the operating condition deviates from the design point, can be suppressed and the operation range (e.g. elevation angle range or the like) in which loss can be reduced can be expanded while a performance reduction during the operation near the design point is suppressed.

In several embodiments, on the first cross-section S1 where the first opening end 72 is located or the second cross-section S2 where the second opening end 74 is located in the spanwise direction in the airfoil 50, the angle A1 satisfying a condition (a) exists within an angle range of −10 degrees or more and 10 degrees or less with reference to a straight line centered on the leading edge 61 and parallel to the inflow direction of the fluid into the airfoil portion 60 in the operating condition at the design point of the device (aircraft 40) to which the airfoil 50 is mounted. Here, the condition (a) is such that the static pressure at the position of the first opening end 72 on the first airfoil surface 65 and the static pressure at the position of the second opening end 74 on the second airfoil surface 66 are equal when the airfoil portion 60 receives a flow of the fluid (arrow F in FIGS. 4A and 5A) in a direction toward the leading edge 61 from a direction of the angle A1.

In the following description, an angle centered on the leading edge 61 in a cross-section orthogonal to the spanwise direction is positive when a direction of the flow of the fluid is a direction facing the first airfoil surface 65 (counterclockwise direction in FIGS. 4A and 5A), and is negative when the direction of the flow of the fluid is a direction facing the second airfoil surface (clockwise direction in FIGS. 4A and 5A).

In the above embodiment, when the airfoil portion 60 receives the flow of the fluid from the above direction of the angle A1, the static pressure at the position of the first opening end 72 on the first airfoil surface 65 and the static pressure at the position of the second opening end 74 on the second airfoil surface 66 are equal. Thus, the flow direction of the fluid toward the airfoil portion 60 (e.g. approximately direction F0 of FIGS. 4A and 5A) is close to the direction of the angle A1 during the operation near the design point of the device (aircraft 40) to which the airfoil 50 is applied. Therefore, there is almost no pressure difference between the position of the first opening end 72 and the position of the second opening end 74 and a flow passing through the communication hole 70 provided in the airfoil portion 60 is hardly generated.

On the other hand, if the operating condition deviates from the design point, a pressure difference is created between the position of the first opening end 72 on the first airfoil surface 65 and the position of the second opening end 74 on the second airfoil surface 66 and a flow passing through the communication hole 70 is generated from the opening end on the high pressure side (e.g. first opening end 72) to the opening end on the low pressure side (e.g. second opening end). By the exit of this flow from the opening end on the low pressure side, momentum is supplied to a flow (main flow) near the airfoil surface provided with the opening end on the low pressure side (first airfoil surface 65 or second airfoil surface 66). Thus, the separation of the flow, which possibly occurs on the airfoil surface, can be suppressed.

Thus, by using the airfoil 50 of the present embodiment, the elevation angle range in which the lift coefficient increases in proportion to the elevation angle is expanded, the lift coefficient is increased up to a greater elevation angle and the drag coefficient is reduced in the high elevation angle region as compared to conventional symmetrical airfoils provided with no communication hole 70 as in the case already described with reference to FIGS. 6 and 7. Therefore, by employing this airfoil 50, the operation range (e.g. elevation angle range or the like) in which loss can be reduced can be expanded.

As just described, according to the above embodiment, the separation of the flow on the airfoil surface, which possibly occurs when the operating condition deviates from the design point, can be suppressed and the operation range (e.g. elevation angle range or the like) in which loss can be reduced can be expanded while a performance reduction during the operation near the design point is suppressed.

In several embodiments, at least one of the first opening end 72 or the second opening end 74 is located closer to the leading edge 61 than a point on the first airfoil surface 65 or the second airfoil surface 66 having a tangent parallel to the chord direction of the airfoil portion 60.

For example, as shown in FIG. 5B, the first opening end 72 may be located closer to the leading edge 61 than a point PT1 on the first airfoil surface 65 having a tangent LT1 parallel to the chord direction (direction of the chord line L1) of the airfoil portion 60. Alternatively, as shown in FIG. 5B, the second opening end 74 may be located closer to the leading edge 61 than a point PT2 on the second airfoil surface 66 having a tangent LT2 parallel to the chord direction (direction of the chord line L1) of the airfoil portion 60.

When the operating condition of the device (aircraft 40) to which the airfoil 50 is applied deviates from the design point, separation may easily occur at a position closer to the trailing edge 62 than the above point PT1 or PT2 (tangent point to the tangent LT1, LT2 parallel to the chord direction) on the first airfoil surface 65 or the second airfoil surface 66. In the respect, since the first opening end 72 or the second opening end 74 is provided closer to the leading edge 61 than the position where separation easily occurs on the first airfoil surface 65 or the second airfoil surface 66 in the above embodiments, the separation of the fluid, which easily occurs on the first airfoil surface 65 or the second airfoil surface 66, can be effectively suppressed under the operating condition deviated from the design point.

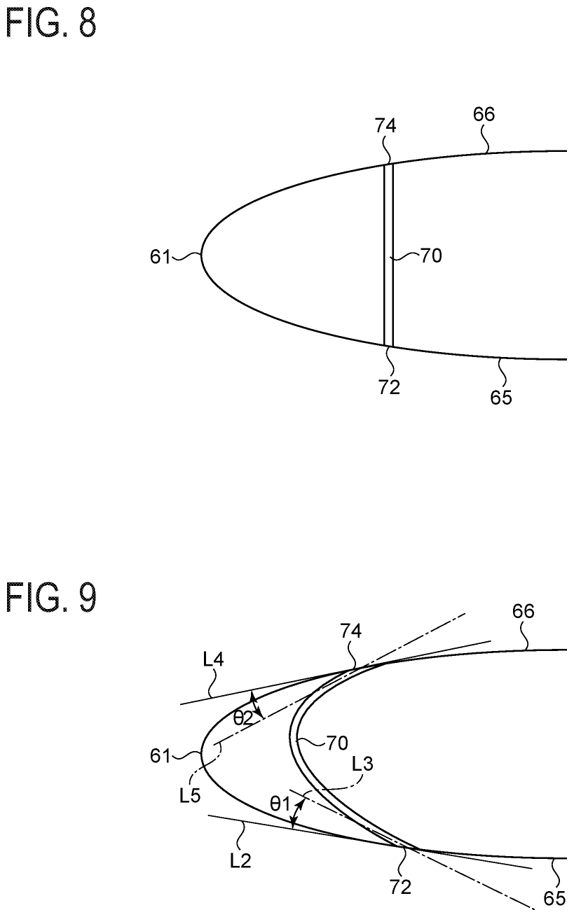

Each of FIGS. 8, 9 and 11 is a diagram schematically showing a partial cross-section orthogonal to the spanwise direction of the airfoil portion 60 according to one embodiment.

In several embodiments, the communication hole 70 extends linearly between the first opening end 72 and the second opening end 74, for example, as shown in FIG. 8. In this case, since the communication hole 70 has a linear shape, a communication hole can be easily formed by machining.

It should be noted that a cross-sectional shape of the communication hole 70 is not particularly limited and may be, for example, circular, elliptical or rectangular.

In several embodiments, an angle θ1 formed by a part closer to the leading edge 61 than the first opening end 72, out of a tangent L2 to the first airfoil surface 65 at the first opening end 72, and the communication hole 70 at the first opening end 72 (direction of a straight line L3 in FIG. 9) is not greater than 45 degrees when viewed from the spanwise direction, for example, as shown in FIG. 9. It should be noted that, in an embodiment shown in FIG. 9, an extending direction of the communication hole 70 at the first opening end 72 is the direction of the straight line L3.

In this case, since the communication hole 70 has a shape along the first airfoil surface 65 at the position of the first opening end 72, mixing loss with the fluid flowing near the first airfoil surface 65 can be reduced when a flow from the communication hole 70 exits from the first opening end 72.

In several embodiments, an angle θ2 formed by a part closer to the leading edge 61 than the second opening end 74, out of a tangent L4 to the second airfoil surface 66 at the second opening end 74, and the communication hole 70 at the second opening end 74 (direction of a straight line L5 in FIG. 9) is not greater than 45 degrees when viewed from the spanwise direction, for example, as shown in FIG. 9. It should be noted that, in the embodiment shown in FIG. 9, an extending direction of the communication hole 70 at the second opening end 74 is the direction of the straight line L5.

In this case, since the communication hole 70 has a shape along the second airfoil surface 66 at the position of the second opening end 74, mixing loss with the fluid flowing near the second airfoil surface 66 can be reduced when a flow from the communication hole 70 exits from the second opening end 74.

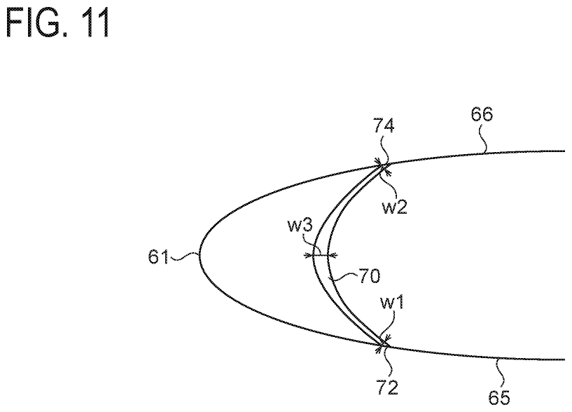

In several embodiments, the communication hole 70 has a part having a larger flow passage area than a flow passage area w1 of the communication hole 70 at the first opening end 72 or a flow passage area w2 of the communication hole 70 at the second opening end 74 between the first opening end 72 and the second opening end 74 when viewed from the spanwise direction, for example, as shown in FIG. 11. It should be noted that, in an embodiment shown in FIG. 11, a flow passage area w3 of the communication hole 70 at a center position between the first opening end 72 and the second opening end 74 in a direction orthogonal to the chord is larger than the flow passage area w1 of the communication hole 70 at the first opening end 72. Further, the flow passage area w3 of the communication hole 70 at the above center position is larger than the flow passage area w2 of the communication hole 70 at the second opening end 74.

As just described, if the communication hole 70 has a part having an enlarged flow passage area between the first opening end 72 and the second opening end 74, a flow velocity of the fluid in that part is reduced and pressure loss is reduced. Thus, the fluid easily flows inside the communication hole 70.

The airfoil 50 according to several embodiments may be applied to a fluid machine such as a gas turbine. For example, in one embodiment, the airfoil 50 may be a strut (supporting member) provided in a passage where working fluid of a gas turbine passes (e.g. exhaust diffuser passage). In this case, the strut (airfoil 50) may be provided such that a spanwise direction of the strut is along a radial direction of a rotor of the gas turbine.

Although the embodiments of the present disclosure have been described above, the present disclosure is not limited to the above embodiments and also include modifications of the above embodiments and appropriate combinations of these embodiments and modifications.

In this specification, an expression indicating a relative or absolute arrangement such as “in a certain direction”, “along a certain direction”, “parallel”, “orthogonal”, “center”, “concentric” or “coaxial” shall be interpreted as not only strictly indicating such an arrangement, but also indicating a relatively displaced state with tolerances or at such an angle or with such a distance as to provide the same functions.

For example, expressions representing a state where things are equal such as “same”, “equal” and “homogeneous” shall be interpreted as not only strictly indicating an equal state, but also indicating a state where a tolerance or such a difference as to provide same functions is present.

Further, an expression indicating a shape such as a rectangular shape or a cylindrical shape shall be interpreted as not only indicating a shape such as a rectangular shape or a cylindrical shape in a geometrically strict sense, but also indicating a shape including an uneven part or a chamfered part in such a range that the same effects are obtained.

Further, in this specification, an expression “comprising”, including” or “having” one constituent element is not an exclusive expression excluding the presence of other constituent element(s).

1. An airfoil comprising:
an airfoil portion having a first airfoil surface and a second airfoil surface respectively extending along a spanwise direction between a leading edge and a trailing edge and having a symmetrical shape with respect to a chord; and
at least one communication hole extending in the airfoil portion and having a first opening end opening to the first airfoil surface and a second opening end opening to the second airfoil surface,
wherein
the first opening end is located on a first cross-section orthogonal to the spanwise direction at a first position in the spanwise direction,
the second opening end is located on a second cross-section orthogonal to the spanwise direction at a second position in the spanwise direction,
in the first cross-section or the second cross-section, an angle A1 satisfying a condition (a) exists within an angle range of −10 degrees or more and 10 degrees or less with reference to a straight line centered on the leading edge and parallel to an inflow direction of fluid into the airfoil portion in an operating condition at a design point of a device to which the airfoil is mounted, and
the condition (a) is such that a static pressure at a position of the first opening end on the first airfoil surface and a static pressure at a position of the second opening end on the second airfoil surface are equal when the airfoil portion receives a flow of the fluid in a direction toward the leading edge from a direction of the angle A1.

2. An airfoil comprising:
an airfoil portion having a first airfoil surface and a second airfoil surface respectively extending along a spanwise direction between a leading edge and a trailing edge and having a symmetrical shape with respect to a chord; and
at least one communication hole extending in the airfoil portion and having a first opening end opening to the first airfoil surface and a second opening end opening to the second airfoil surface,
wherein
the first opening end is located on a first cross-section orthogonal to the spanwise direction at a first position in the spanwise direction,
the second opening end is located on a second cross-section orthogonal to the spanwise direction at a second position in the spanwise direction, and
when X1 represents a dimensionless chord length position (%) of the first opening end with reference to the leading edge on the first cross-section and X2 represents a dimensionless chord length position (%) of the second opening end with reference to the leading edge on the second cross-section,
an angle of an inflow direction of fluid into the airfoil portion with reference to a chord direction in an operating condition at a design point of a device to which the airfoil is mounted is 0 degrees, and an absolute value |X1-X2| of a difference between the dimensionless chord length position X1 of the first opening end and the dimensionless chord length position X2 of the second opening end is not greater than 5%, or
the angle of the inflow direction of the fluid into the airfoil portion with reference to the chord direction in the operating condition at the design point of the device to which the airfoil is mounted is greater than 0 degrees, the inflow direction is a direction facing the first airfoil surface, and the dimensionless chord length position X1 of the first opening end opening to the first airfoil surface is larger than the dimensionless chord length position X2 of the second opening end opening to the second airfoil surface.

3. The airfoil according to claim 1, wherein at least one of the first opening end or the second opening end is located closer to the leading edge than a point on the first airfoil surface or the second airfoil surface having a tangent parallel to a chord direction of the airfoil portion.

4. The airfoil according to claim 1, wherein the communication hole extends linearly between the first opening end and the second opening end.

5. The airfoil according to claim 1, wherein an angle formed by a part closer to the leading edge than the first opening end, out of a tangent to the first airfoil surface at the first opening end, and the communication hole at the first opening end is not greater than 45 degrees when viewed from the spanwise direction.

6. The airfoil according to claim 1, wherein an angle formed by a part closer to the leading edge than the second opening end, out of a tangent to the second airfoil surface at the second opening end, and the communication hole at the second opening end is not greater than 45 degrees when viewed in the spanwise direction.

7. The airfoil according to claim 1, wherein the first opening end and the second opening end are located at the same position in the spanwise direction.

8. The airfoil according to claim 1, wherein the first opening end and the second opening end are located at different positions in the spanwise direction.

9. A machine comprising the airfoil according to claim 1.
